(19) United States
(12) Patent Application Publication
(10) Pub. No.: US 2011/0158758 A1
(43) Pub. Date: Jun. 30, 2011

(54) Lifting Machine Base Assembly for a Machine Tool

(75) Inventor: Cheng-Hung CHIU, Taichung (TW)

(73) Assignee: REXON INDUSTRIAL CORP., LTD., Taichung (TW)

(21) Appl. No.: 12/976,062

(22) Filed: Dec. 22, 2010

(30) Foreign Application Priority Data
Dec. 30, 2009 (TW) 098145993

(51) Int. Cl. B23Q 1/01

(52) U.S. Cl. 408/234

(57) ABSTRACT

A machine base assembly for a machine tool mainly has a driven wheel set coupled to the machine base. The driven wheel set is driven by a driving device to move downwards relative to the machine base for contacting a supporting surface so that the machine base can be lifted from the supporting surface and moved by rotation of the driven wheel set to conveniently move the machine tool to a desired position.

This application claims, under 35 U.S.C. §119, priority to Taiwanese Application No. 098145993, filed Dec. 30, 2009, which application is hereby incorporated by reference in its entirety, inclusive of the specification, claims, and drawings.

### FIELD OF THE INVENTION

The present disclosure relates to a machine tool and more particularly, to a lifting machine base assembly for a machine tool.

### BACKGROUND

Regular floor type machine tools (such as drill presses) are commonly quite large and very heavy, and are not easily movable by an operator. In particular, in order to move a floor type machine tool from one place to another, several persons are typically required to join together and to lift the floor type machine tool above the floor for movement thereof. Thus, a large amount of labor and time are required in order to move a floor type machine tool. Additionally, there is substantial risk of personal injury or machine tool damage that may accidentally occur during movement of the machine tool. Therefore, moving a floor type machine tool in this manner is difficult and dangerous.

### SUMMARY

The present disclosure has been accomplished under the circumstances in view. Accordingly, the present disclosure describes exemplary embodiments of a machine base assembly for a machine tool, which includes a liftable driven wheel set so that the operator can operate the machine tool in place on a floor or other supporting surface when the driven wheels are not lowered, and can conveniently move the machine tool when the driven wheels are lowered into contact with the floor.

To achieve this and other objects of the present disclosure, a machine base assembly for a machine tool includes a machine base, at least one driven wheel set and at least one driving device. Each driven wheel set includes a driven shaft and two driven wheels. The driven shaft is rotatably mounted within the machine base. The driven wheels are respectively and eccentrically mounted on the two (first and second) distal ends of the driven shaft and are movable up and down relative to the machine base subject rotation of the driven shaft. Each driving device is connected to the driven shaft of one driven wheel set and is operable by an externally applied force to rotate the driven shaft of the respective driven wheel set between a first position and a second position.

When the driving device is in the first position, the machine base is maintained in contact with the floor. At this time, the operator can safely use the machine tool in place on the floor.

When the driving device is in the second position, the driven wheels of each driven wheel set are lowered into contact with the floor to lift the machine base from the floor. At this time, the operator can conveniently move the machine tool to a desired location by means of rotating the driven wheels.

In one embodiment of the present disclosure, there are two driven wheel sets. In this case, two driving devices can be provided for moving the two driven wheel sets respectively, or alternatively, a transmission shaft can be coupled between the two driven wheel sets for synchronously operating the two driven wheel sets.

In another alternate form of the present disclosure, the machine base assembly further comprises a transmission wheel set that includes a liftable transmission wheel. When the driving device is in the second position, the driven wheels of the driven wheel set are lowered into contact with the floor, and the transmission wheel of the transmission wheel set is also lowered into contact with the floor by way of the transmission operation of the transmission shaft connecting the driven wheel set with the transmission wheel set.

### BRIEF DESCRIPTION OF THE DRAWINGS

FIG. 1 is an elevational view of a machine base assembly for a machine tool in accordance with a first embodiment of the present disclosure.

FIG. 2 is an elevational view of the machine tool using the machine base assembly in accordance with the first embodiment of the present disclosure.

FIG. 3 is an exploded view of a driven wheel set of the machine base assembly in accordance with the first embodiment of the present disclosure after removal from the machine tool.

FIG. 4 is a sectional view of the machine base assembly in accordance with the first embodiment of the present disclosure, illustrating the driving device in the first position.

FIG. 5 is similar to FIG. 4 but illustrating the driving device in the second position.

FIG. 6 is an elevational view, partially exploded, of a machine base assembly in accordance with a second embodiment of the present disclosure.

FIG. 7 is a sectional view of the machine base assembly in accordance with the second embodiment of the present disclosure, illustrating the driving devices in the first position.

FIG. 8 is similar to FIG. 7 but illustrating the driving devices in the second position.

FIG. 9 is an elevational view of a machine base assembly in accordance with a third embodiment of the present disclosure.

FIG. 10 is an elevational view of the driven wheel sets of the machine base assembly in accordance with the third embodiment of the present disclosure after removal from the machine tool.

FIG. 11 is a sectional view of the machine base assembly in accordance with the third embodiment of the present disclosure, illustrating the driving device in the first position.

FIG. 12 is similar to FIG. 11 but illustrating the driving device in the second position.

FIG. 13 is an elevational view of a machine base assembly in accordance with a fourth embodiment of the present disclosure.

FIG. 14 is an exploded view of the driven wheel set and the transmission wheel set of the machine base assembly in accordance with the fourth embodiment of the present disclosure after removal from the machine tool.

FIG. 15 is a sectional view of the machine base assembly in accordance with the fourth embodiment of the present disclosure, illustrating the driving device in the first position.

FIG. 16 is similar to FIG. 15 but illustrating the driving device in the second position.

### DETAILED DESCRIPTION

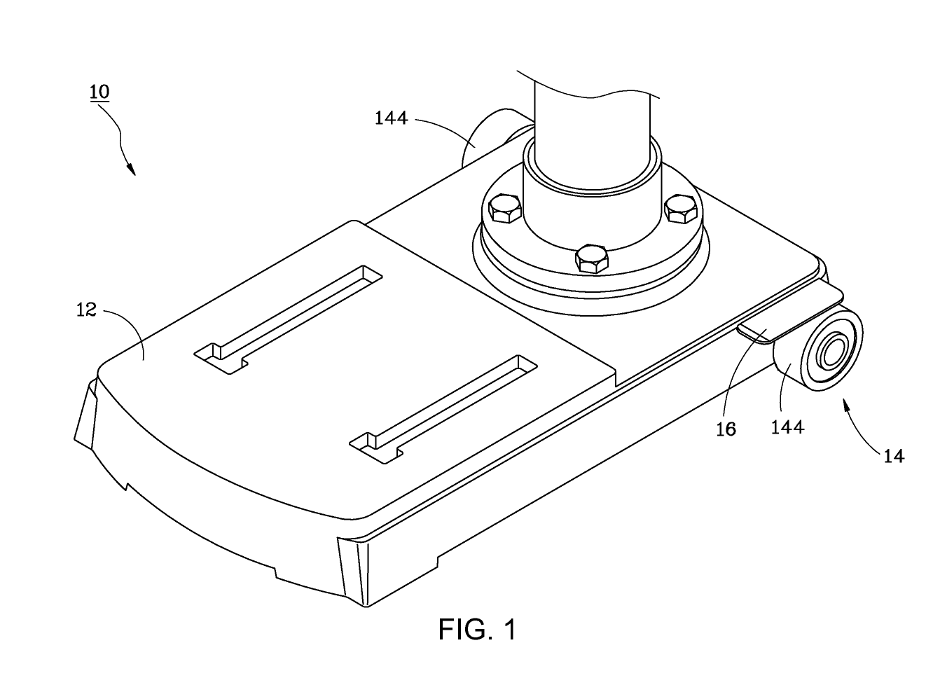

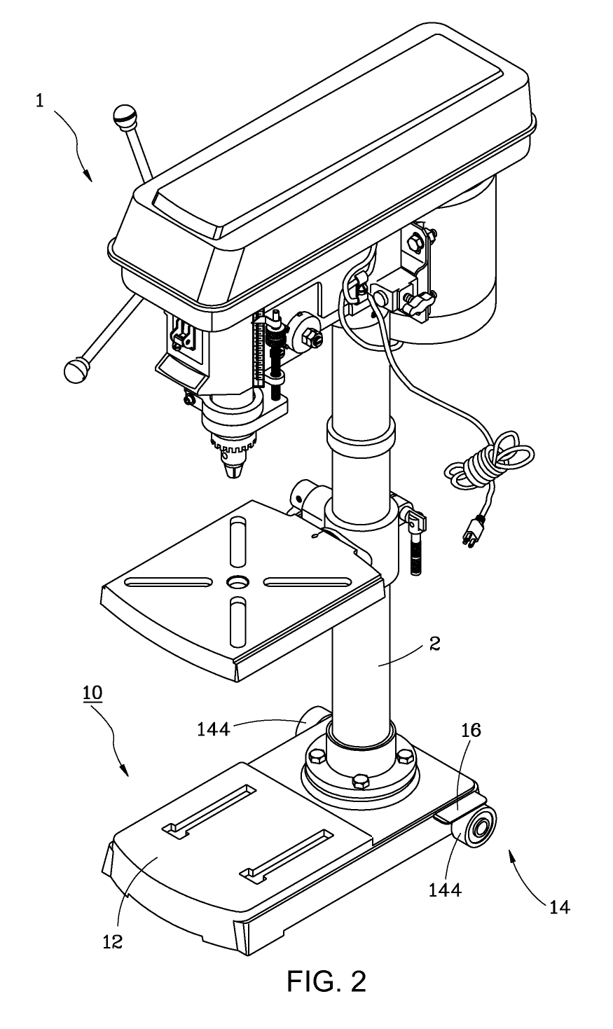

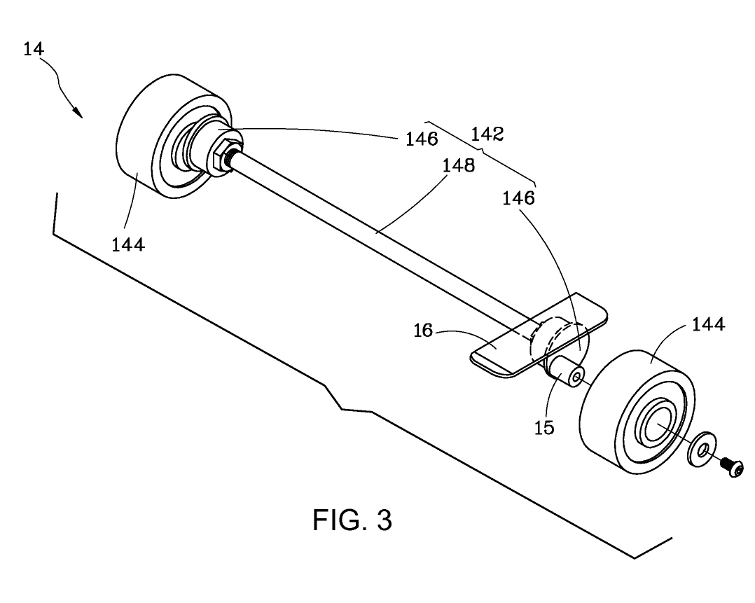

Referring to FIGS. 1 through 3, a machine base assembly 10 in accordance with a first embodiment of the present disclosure is shown installed in a machine tool 1. The machine base assembly 10 includes a machine base 12, a driven wheel set 14, and a driving device 16.

The machine base 12 is fixedly connected to a support member 2 of a machine tool 1 (for example, a drill press) to provide stable support on a supporting surface to the machine tool 1.

The driven wheel set 14 includes a driven shaft 142 and two driven wheels 144 mounted at respective first and second opposed distal ends of the driven shaft 142. The driven shaft 142 includes two shaft blocks 146 connected to opposed first and second ends of a shaft member 148. The shaft blocks 146 are each rotatably mounted in respective sides of the machine base 12. Each shaft block 146 includes an outwardly protruding eccentric axle 15 mounted thereon. The shaft member 148 has its two opposed distal ends respectively fastened to the two shaft blocks 146 by a screw joint. The driven wheels 144 are respectively pivotally mounted on the eccentric axles 15 of the shaft blocks 146, and are movable up and down with respect to the machine base 12 subject to rotation of the driven shaft 142 within the sides of the machine base 12.

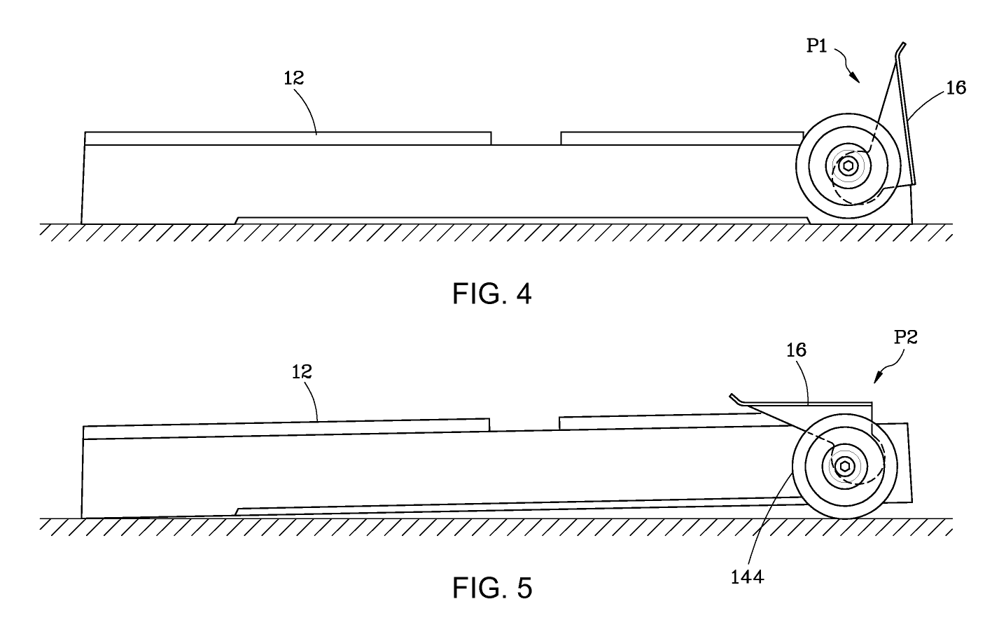

The driving device 16 is installed at one of the shaft blocks 146 of the driven shaft 142, and is movable by an externally applied force to rotate the driven shaft 142. The driving device 16 can be integrally formed with the shaft block 146, for example as an extension of a flange of the shaft block (generally shown in FIGS. 4 and 5) or can be connected to the shaft block 146 in any other suitable manner, such as, for example, welding or brazing the driving device 16 to the shaft block 146.

When the driving device 16 receives no externally applied force, it is retained in a first position P1, as shown in FIG. 4, where the machine base 12 is maintained in contact with the floor, and therefore the machine tool 1 is firmly held in position for operation by a user.

When the driving device 16 is forced downwards by an externally applied force from the first position P1 to a second position P2, as shown in FIG. 5, the driven shaft 142 is synchronously rotated within the sides of the machine base 12, and the driven wheels 144 are moved with the eccentric axles 15 and lowered into contact with the floor, and therefore the machine base 12 is lifted from the floor by the driven wheels 144. In this position shown in FIG. 5, the machine tool 1 can be moved by an operator with the driven wheels 144 from one place to another.

Additionally, the relationship of the screw joint between each end of the shaft member 148 and the associated shaft block 146 allows adjustment of the gap between the driven wheels 144 and the machine base 12 to be optimized.

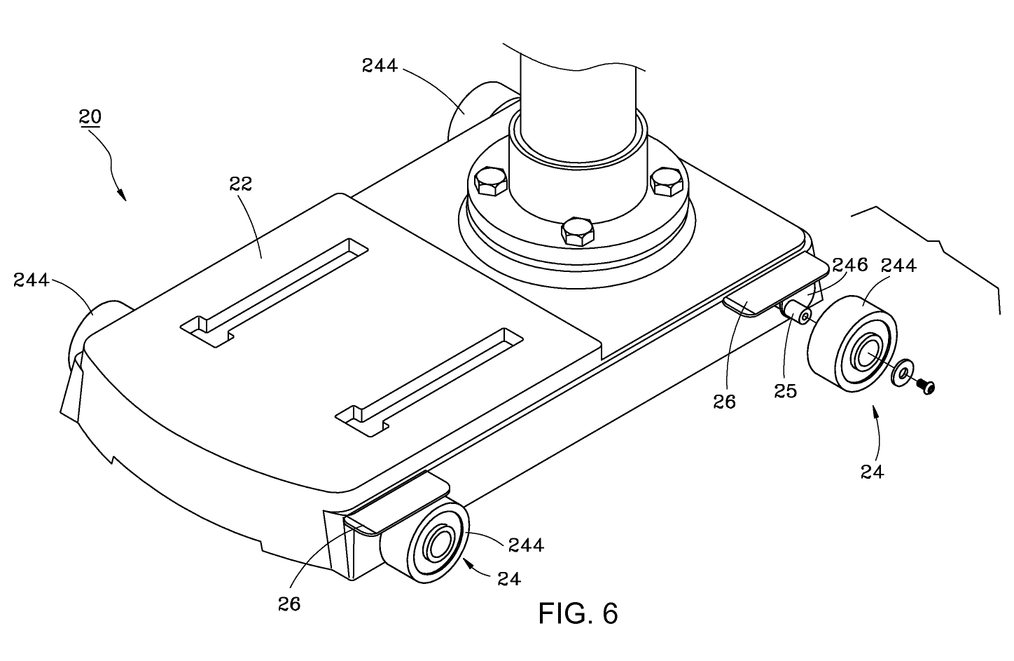

FIG. 6 illustrates a machine base assembly 20 in accordance with a second embodiment of the present disclosure. This second embodiment is substantially similar to the aforesaid first embodiment with the exception that the machine base assembly 20 of this second embodiment includes two driven wheel sets 24 and two driving devices 26. Each driving device 26 is connected to one shaft block 246 of one respective driven wheel set 24. Similarly to the embodiment of FIGS. 1-5, the driven wheel sets also include a driven shaft connected at first and second opposed distal ends to the respective shaft blocks 246, which are mounted in respective sides of the machine base 22, and the wheels 244 of the two driven wheel sets 24 are respectively connected to eccentric axles 25 mounted on the respective shaft blocks 246.

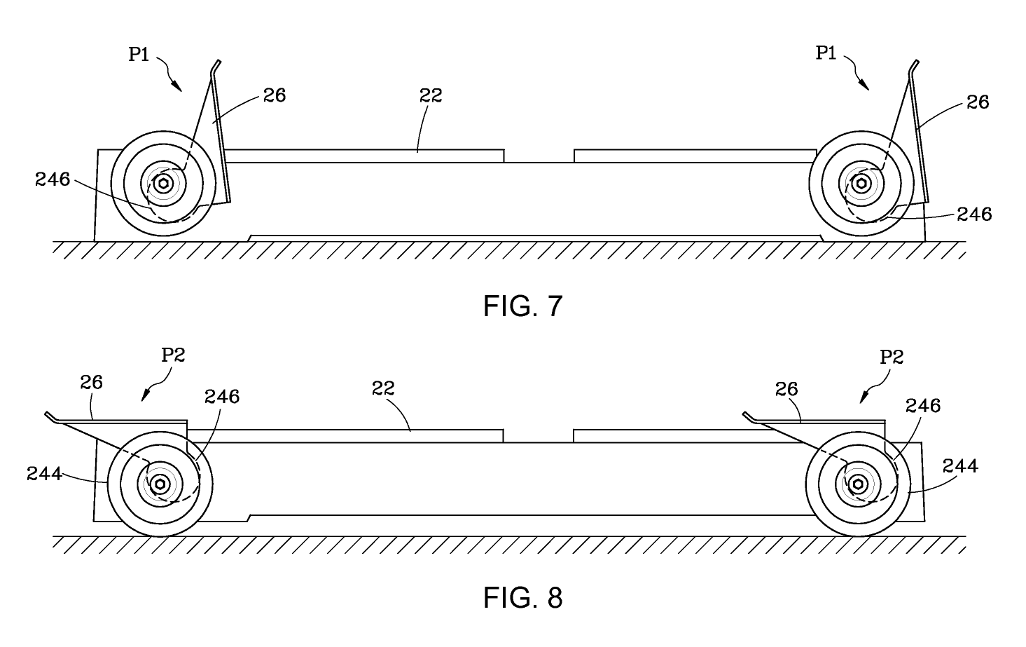

When the driven devices 26 are in the first position P1, as shown in FIG. 7, the machine base 22 is maintained in contact with the floor. When the driving devices 26 are forced downwards by an externally applied force from the first position P1 to a second position P2, as shown in FIG. 8, the driven wheels 244 are moved in the same manner as previously discussed with the eccentric axles 25 and lowered into contact with the floor, and therefore the machine base 22 is lifted from the floor by the driven wheels 244, allowing the machine tool 1 to be moved with the driven wheels 244 from one position to another by an operator.

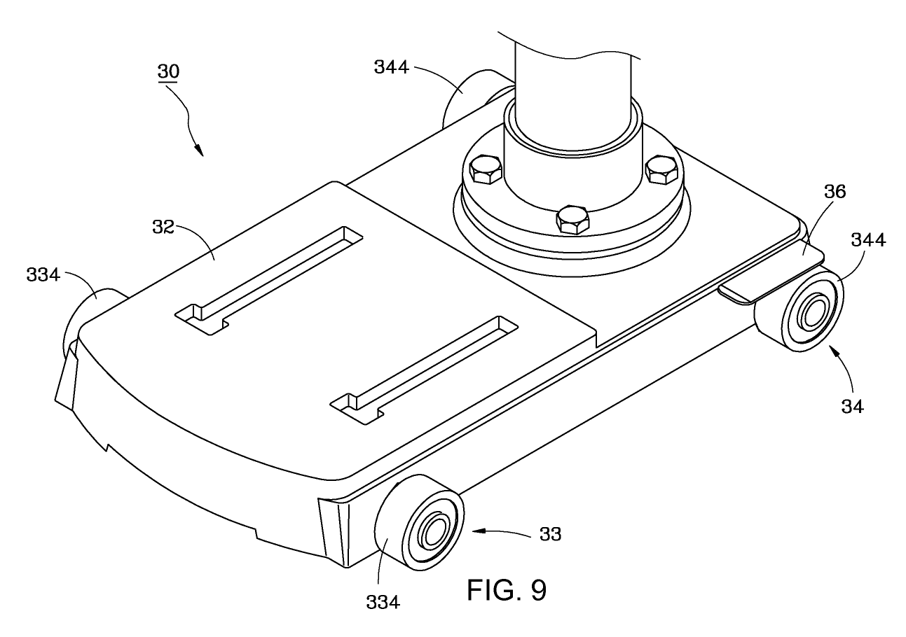

FIG. 9 illustrates a machine base assembly 30 in accordance with a third embodiment of the present disclosure. This third embodiment is substantially similar to the aforesaid first embodiment with the exception that the machine base assembly 30 of this third embodiment includes two (first and second) driven wheel sets 33, 34, a driving device 36, and one transmission shaft 38.

The driving device 36 is connected to one shaft block 346 of the driven shaft 342 of one driven wheel set 34.

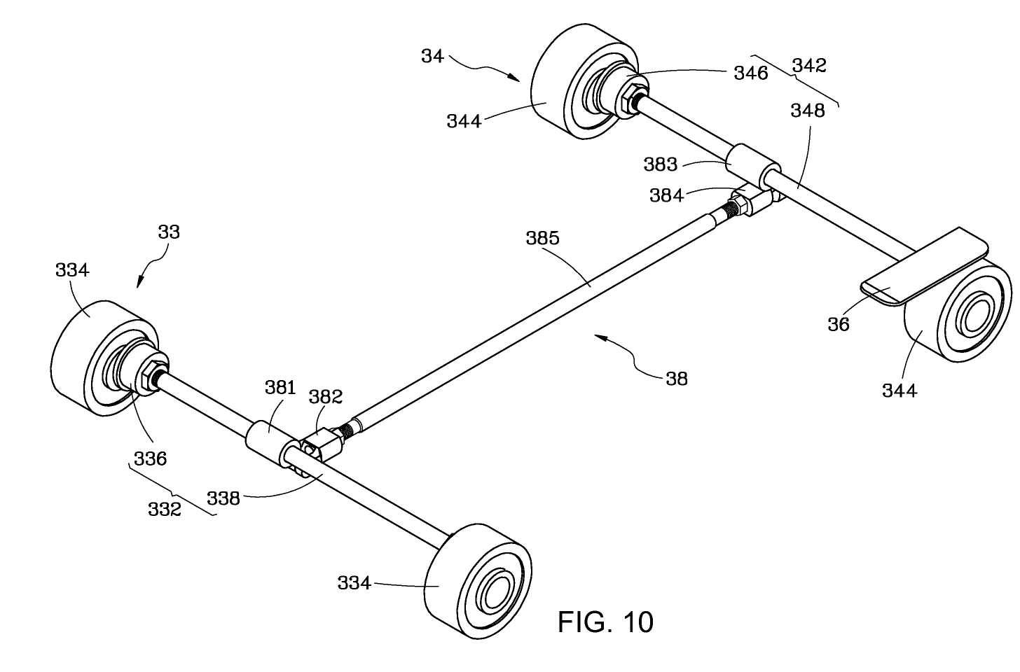

As seen in FIG. 10, transmission shaft 38 includes a first transmission member 381, a second transmission member 382, a third transmission member 383, a fourth transmission member 384 and a fifth transmission member 385.

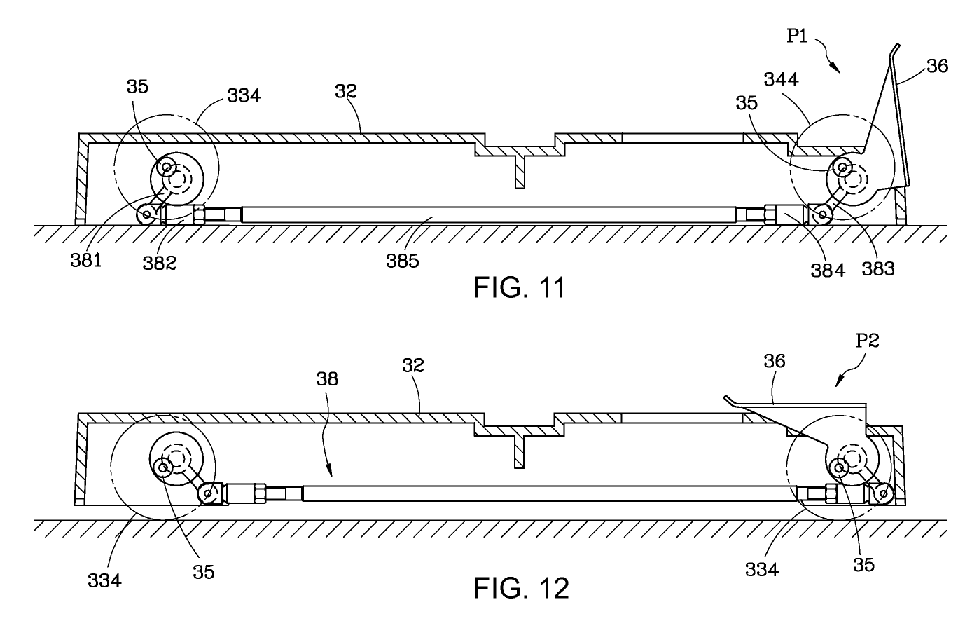

As best seen in FIGS. 10 and 11, the first transmission member 381 is connected at a top end thereof to the shaft member 338 of the first driven wheel set 33 and is pivotally connected at a bottom end thereof to the second transmission member 382. The third transmission member 383 is connected at a top end thereof to the shaft member 348 of the second driven wheel set 34 and a bottom end thereof is pivotally connected to the fourth transmission member 384. The fifth transmission member 385 has opposed first and second distal ends respectively fastened to the second transmission member 382 and the fourth transmission member 384 by a respective screw joint. By way of adjustment to the screw joint between the fifth transmission member 385 and the second transmission member 382 and the screw joint between the fifth transmission member 385 and the fourth transmission member 384, the transmission efficiency of the transmission shaft 38 can be optimized.

When the driving member 36 is moved from the first position P1 to the second position P2 by an externally applied force, as shown in FIGS. 11 and 12, the driven shaft 342 is synchronously rotated, causing each eccentric axle 35 connected with the shaft block 346 of the driven shaft 342 of the driven wheel set 34 to lower the respective driven wheel 344 into contact with the floor in a manner as previously discussed. At the same time, the other driven shaft 332 of the driven wheel set 33 is simultaneously rotated by movement of the transmission shaft 38, causing the shaft member 338 to move the respective eccentric axles 35 connected with the shaft blocks 336 of the driven shaft 332 of the driven wheel set 33 to lower the respective driven wheels 334 into contact with the floor, and therefore the machine base 32 is lifted from the floor by the four wheels 344, 334 contacting the floor.

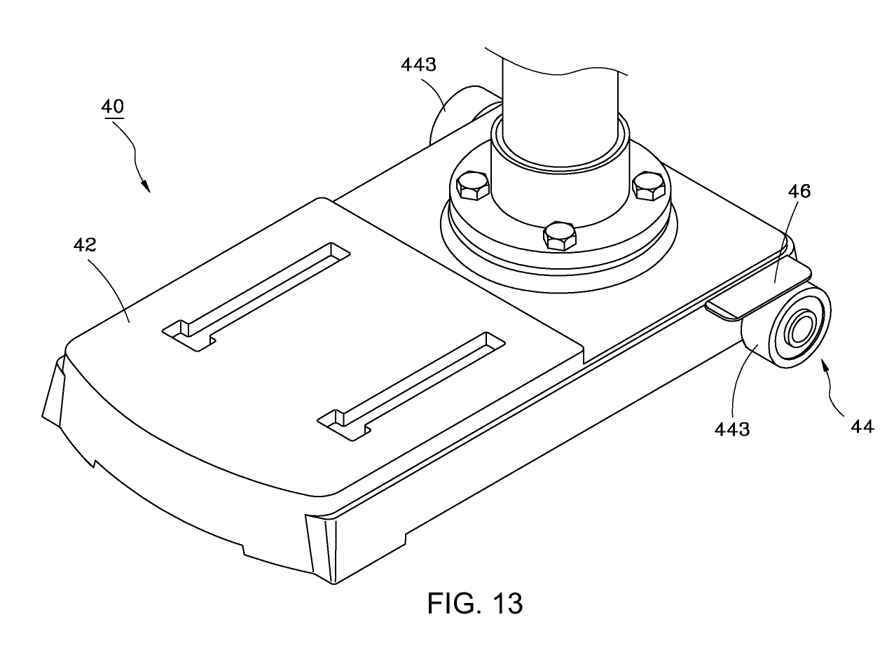

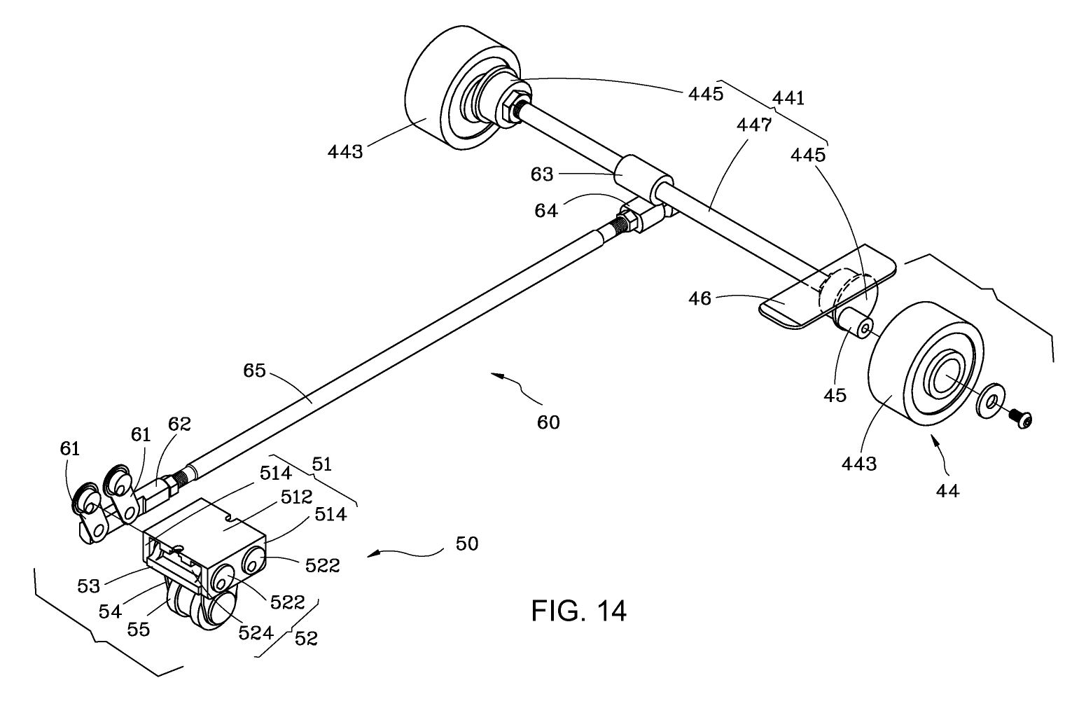

FIGS. 13 and 14 illustrate a machine base assembly 40 in accordance with a fourth embodiment of the present disclosure. This fourth embodiment is substantially similar to the aforesaid first embodiment with the exception that the machine base assembly 40 of this fourth embodiment includes one driven wheel set 44, one transmission wheel set 50, and a transmission shaft 60.

The transmission wheel set 50 includes a wheel holder frame 51, two parallel transmission axles 52, a lift board 53, a wheel bracket 54, and a transmission wheel 55. The wheel holder frame 51 has a top wall 512 and two opposed sidewalls 514. The top wall 512 is affixed to the bottom side of the machine base 42 in any suitable manner. The sidewalls 514 are perpendicularly downwardly extended from two opposite lateral sides of the top wall 512.

Each transmission axle 52 includes two disk-like end portions 522 respectively rotatably mounted in the two opposed sidewalls 514 of the wheel holder frame 51, and an eccentric shank 524 connected between the two disk-like end portions 522 and suspended between the two sidewalls 514 of the wheel holder frame 51. Thus, rotation of the parallel transmission axles 52 can move the lift board 53 upwards or downwards relative to the machine base 42. The wheel bracket 54 is pivotally mounted on the bottom side of the lift board 53 and is movable with the lift board 53 upwards or downwards relative to the machine base 42. The transmission wheel 55 is pivotally mounted in the wheel bracket 54.

The transmission shaft 60 includes two first transmission members 61, a second transmission member 62, a third transmission member 63, a fourth transmission member 64, and a fifth transmission member 65. Each first transmission member 61 has a top end thereof connected to one disk-like end portion 522 and a bottom end thereof pivotally connected to the second transmission member 62. The third transmission member 63 has a top end thereof connected to a shaft member 447 of a driven shaft 441 of the driven wheel set 44, and a bottom end thereof pivotally connected to the fourth transmission member 64. The fifth transmission member 65 has first and second opposed distal ends respectively fastened to the second transmission member 62 and the fourth transmission member 64 by a respective screw joint.

Thus, when the driven shaft 441 of the driven wheel set 44 is rotated by operation of the driving device 46, the rotary driving force is transferred in proper order through the third transmission member 63, the fourth transmission member 64, the fifth transmission member 65, the second transmission member 62, and the first transmission members 61 to the transmission axles 52, achieving synchronous rotation thereof. Further, by way of operation of the screw joint between the fifth transmission member 65 and the second transmission member 62 and the screw joint between the fifth transmission member 65 and the fourth transmission member 64, the transmission efficiency of the transmission shaft 60 can be optimized.

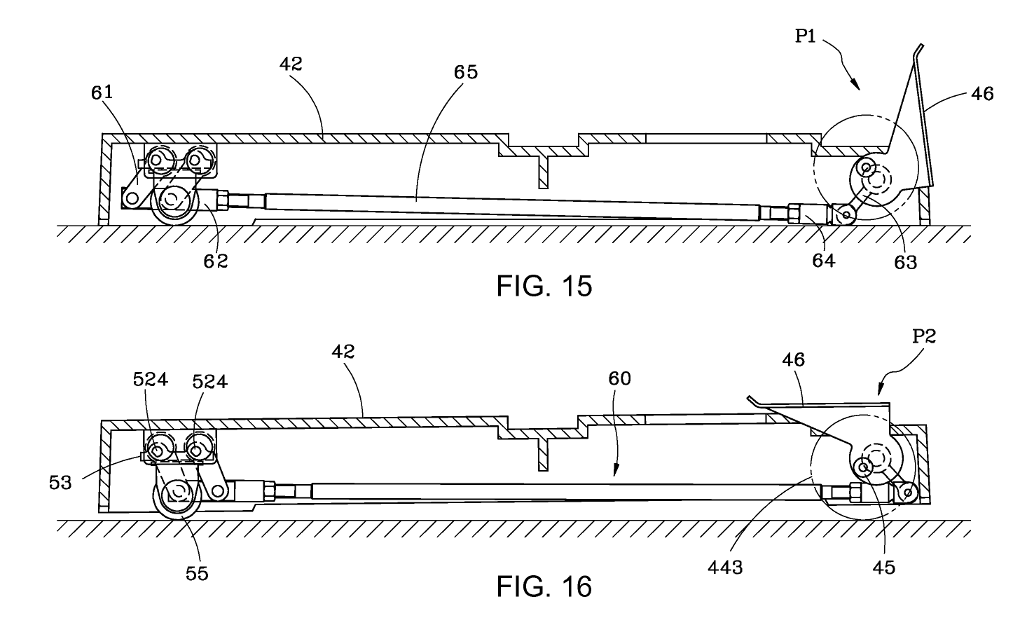

When the driving device 46 is in the first position P1, as shown in FIG. 15, the machine base 42 is maintained in contact with the floor, and therefore the machine tool 1 is positively and stably held in position for operation by the operator.

When the driving device 46 is moved from the first position P1 to the second position P2, as shown in FIG. 16, the driven shaft 441 is synchronously rotated to move the respective eccentric axles 45, connected to the respective shaft blocks 445, which rotate in respective sides of the machine base 42, in order to lower the driven wheels 443 into contact with the floor. At the same time, the rotary driving force is also transferred through the transmission shaft 60 to the first transmission members 61, causing the lift board 53 to be moved downwards, by the eccentric shanks 524 of the transmission axles 52, into contact with the floor, and therefore the machine base 42 is lifted by the driven wheels 443 of the driven wheel set 44 and the transmission wheel 55 of the transmission wheel set 50, for enabling the operator to move the machine base 1 to a desired location by means of the driven wheels 443 and the transmission wheel 55.

In conclusion, the machine base assembly enables the machine base to be firmly and stably supported on the floor before lowing of the driven wheels so that the operator can operate the machine tool conveniently and safely. When the driven wheels are lowered into contact with the floor, the machine base is lifted from the floor, and the operator can move the machine tool to a desired position by means of rotating the driven wheels. Thus, the use of the machine base assembly facilitates the operation and movement of the machine tool at a high level of safety.

Further, it is to be understood that the designs of the present disclosure may be variously embodied. For example, the shaft member of the driven wheel set can be connected to the shaft block eccentrically, and the driven wheels can be coaxially connected to the shaft blocks. Thus, when the eccentrically mounted shaft member is rotated, the driven wheels are moved upwards or downwards relative to the machine base.

Although particular embodiments of the disclosure have been described in detail for purposes of illustration, various modifications and enhancements may be made without departing from the spirit and scope of the disclosure. Accordingly, the disclosure is not to be limited except as by the appended claims.

What is claimed is:

1. A machine base assembly for use in a machine tool, comprising:
a machine base;
at least one driven wheel set, each said driven wheel set having a driven shaft and first and second driven wheels, said driven shaft being rotatably mounted in said machine base, said first and second driven wheels being eccentrically mounted on respective first and second distal ends of said driven shaft and movable up and down relative to said machine base by way of rotation of said driven shaft within said machine base; and
at least one driving device connected to the driven shaft of each at least one driven wheel set and operable by an externally applied force to rotate the driven shaft of each said driven wheel set between a first position where said machine base is maintained in contact with a supporting surface and a second position where the driven wheels of each at least one driven wheel set are lowered into contact with the supporting surface to lift said machine base from the supporting surface.

2. The machine base assembly according to claim 1, wherein said driven shaft of each at least one driven wheel set comprises two shaft blocks and one shaft member, said two shaft blocks being rotatably mounted in respective sides of said machine base, each said shaft block comprising an eccentric axle pivotally connected to the associated driven wheel, said shaft member having two distal ends thereof respectively connected to said shaft blocks by a respective screw joint; and said driving device is connected to one said shaft block.

3. The machine base assembly according to claim 1, having two driven wheel sets, and having two respective driving devices.

4. The machine base assembly according to claim 3, wherein the driven shaft of each said driven wheel set comprises two shaft blocks and one shaft member, said two shaft blocks being rotatably mounted in respective sides of said machine base, each said shaft block comprising an eccentric axle, said shaft member having two distal ends thereof respectively connected to said shaft blocks by a respective screw joint; said two driving devices respectively connected to one shaft block of one driven shaft of one said driven wheel set.

5. The machine base assembly according to claim 1, further comprising a transmission shaft, and having two driven wheel sets; said transmission shaft has two distal ends thereof respectively connected to the driven shafts of said two driven wheel sets for synchronous rotation of the driven shafts; said driving device is connected to the driven shaft of one of the two driven wheel sets.

6. The machine base assembly according to claim 5, wherein the driven shaft of each said driven wheel set comprises two shaft blocks and a shaft member, said shaft blocks being rotatably mounted in respective sides of said machine base, each said shaft block comprising an eccentric axle, said shaft member having two distal ends thereof respectively fastened to said two shaft blocks by a respective screw joint; said two driving devices respectively connected to one shaft block of the driven shaft of one said driven wheel set.

7. The machine base assembly according to claim 5, wherein the transmission shaft comprises a first transmission member, a second transmission member, a third transmission member, a fourth transmission member, and a fifth transmission member, said first transmission member having a top end thereof connected to the driven shaft of one said driven wheel set and a bottom end thereof pivotally connected to said second transmission member, said third transmission member having a top end thereof connected to the driven shaft of the other said driven wheel set and a bottom end thereof pivotally connected to said fourth transmission member, said fifth transmission member having two distal ends thereof respectively connected to said second transmission member and said fourth transmission member by a respective screw joint.

8. The machine base assembly according to claim 1, further comprising a transmission wheel set and a transmission shaft, wherein said transmission wheel set comprises a wheel holder frame, a transmission axle, a lift board, a wheel bracket, and a transmission wheel, said wheel holder frame being affixed to a bottom side of said machine base, said transmission axle being rotatably mounted in said wheel holder frame and having an eccentric shank, said lift board being connected to the eccentric shank of said transmission axle for moving said machine base up and down by rotation of said transmission axle, said wheel bracket being mounted in said lift board, said transmission wheel being pivotally mounted in said wheel bracket; said transmission shaft having two distal ends thereof respectively connected to the driven shaft of said at least one driven wheel set and to the transmission axle of said transmission wheel set for allowing said driven shaft of said driven wheel set and said transmission axle of said transmission wheel set to be rotated synchronously such that when said driving device is in said first position, said machine base is maintained in contact with the supporting surface, and when said driving device is in said second position, said driven wheels of said at least one driven wheel set are lowered into contact with the supporting surface and said lift board of said transmission wheel set is lowered by said transmission shaft to force said transmission wheel into contact with the supporting surface.

9. The machine base assembly according to claim 8, wherein said wheel holder frame of said transmission wheel set comprises two opposed sidewalls; said transmission axle comprises two disk-like end portions respectively rotatably mounted in the two opposed sidewalls of said wheel holder frame and an eccentric shank connected between said two disk-like end portions; and said lift board is suspended between the two opposed side walls of said wheel holder frame.

10. The machine base assembly according to claim 8, wherein said transmission shaft comprises a first transmission member, a second transmission member, a third transmission member, a fourth transmission member, and a fifth transmission member, said first transmission member having a top end thereof connected to said transmission axle and a bottom end thereof pivotally connected to said second transmission member, said third transmission member having a top end thereof connected to said driven shaft and a bottom end thereof pivotally connected to said fourth transmission member, said fifth transmission member having two distal ends thereof respectively connected to said second transmission member and said fourth transmission member by a respective screw joint.

11. The machine base assembly according to claim 8, wherein said wheel bracket of said transmission wheel set is pivotally connected to said lift board.

12. A machine base assembly for use in a machine tool, comprising:
a base;
a driven wheel set having a driven shaft and first and second driven wheels, said driven shaft being rotatably mounted in said machine base via first and second shaft blocks at opposed ends thereof, said first and second driven wheels being respectively eccentrically mounted on the first and second shaft blocks, and movable up and down relative to said machine base by way of rotation of said driven shaft within said machine base; and
at least one driving device connected to one of the first and second shaft blocks and operable by an externally applied force between a first and second position to rotate the driven shaft of the driven wheel set where said machine base is maintained in contact with a supporting surface and where the driven wheels of the driven wheel set are lowered into contact with the supporting surface to lift said machine base from the supporting surface.
